(19) United States
(12) Patent Application Publication
(10) Pub. No.: US 2007/0038415 A1
(43) Pub. Date: Feb. 15, 2007

(54) Cable quantity totalizing device, cable quantity totalizing method and cable quantity totalizing program

(75) Inventors: Yuki Okada, Kawasaki-Shi (JP); Mitsuaki Yoshida, Fuchu-Shi (JP); Takashi Fujisawa, Yokohama-Shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 11/503,151

(22) Filed: Aug. 14, 2006

(30) Foreign Application Priority Data
Aug. 15, 2005 (JP) 2005-235427

(51) Int. Cl. G06F 17/50

(52) U.S. Cl. 703/1

(57) ABSTRACT

A cable quantity totalizing device includes: an input unit to perform an inputting operation of information; a memory unit as a database to store arrangement information and part identification information related to a three dimensional model of a contact point part having a contact point with a cable, arrangement information, part identification information and attribute information related to a three dimensional model of a cable container part for containing a cable when placed, cable specification information on the cable, and occupying rate information on the respective cable container parts; a three dimensional model arrangement adjusting unit to arrange a three dimensional model in a three dimensional coordinate system obtained by simulating a space where a cable is actually placed; a cable route search unit to read out the information on the cable container part stored in the database to search for a cable route with a shortest cable length; a cable route calculation unit to calculate the cable length in the cable route searched for by the optimum cable route search unit; and a display unit to display the cable route search result and the cable length calculation result.

### BACKGROUND OF THE INVENTION

1. Field of the Invention

The present invention relates to a cable quantity totalizing device, a cable quantity totalizing method, and a cable quantity totalizing program, related to optimum route design and cable length calculation for cables placed in a chemical plant or a power generation plant (thermal, atomic, hydraulic, or the like) by using arrangement data of a three dimensional arrangement adjusting CAD device and cable specification data.

2. Related Art

A chemical plant or a power generation plant includes an extremely large number of distribution boards and electrical devices, and accordingly, many cables connecting them are required. It takes a large amount of labor to determine at a plant planning stage as to how the many cables are placed, in what cable route, with high precision. For this reason, an optimum placing route is not previously determined in the past. As a result, changes in selected conductor size of a power supply cable, which has a correlation with the cable length, and the total length of instrumentation control cables occurred, which affects on calculation of the quantity of cable preparation materials and the physical construction amount.

Under the circumstances, a technology for searching a cable rout in a plant has been developed. For example, according to a technology described in Japanese Unexamined Patent Application Publication No. 2-71373, an optimum route is searched for with respect to each of arrangement objects to determine a tentative cable route, and then validation is conducted as to whether or not arrangement is enabled on the tentative cable route. When the arrangement is enabled, the validated cable route is determined as the optimum cable route.

In addition, according to a technology described in Japanese Unexamined Patent Application Publication No. 10-21269, at the time of placing cables, with respect to a cable placing network formed by linking a plurality of predetermined cable container members, on consideration of the volume of the cable container members, an optimum cable placing route is automatically determined.

However, according to the prior art described in Japanese Unexamined Patent Application Publication No. 2-71373, if the number of the individual placement objects is increased, it takes a long period of time to perform the validation for the optimum route.

Meanwhile, the prior art described in Japanese Unexamined Patent Application Publication No. 10-21269 uses cable run parts such as cable trays, whose number of the parts is smaller than that of the cables and which significantly affects the cable route. Therefore, it is possible to suppress increasing in the optimum route vilification time along with the parts number increase. With an advantage in which it is possible to quickly and easily achieve the optimum cable route search as compared with the search with use of only cables, the prior art described in Japanese Unexamined Patent Application Publication No. 10-21269 is superior to the prior art described in Japanese Unexamined Patent Application Publication No. 2-71373.

However, even with the prior art described in Japanese Unexamined Patent Application Publication No. 10-21269, in the cable route and quantity calculation result, since the cable route is not displayed in a three dimensional manner by using a three dimensional model, a user cannot instinctively or visually recognize the cable route. Therefore, even when the user can find out passing-through contact points or cable trays, there is encountered such a problem as that it is difficult to judge whether the calculated cable length is actually appropriate.

Meanwhile, in a power generation plant, the cable is one of the components, and the number of the cable parts may reach as many as several tens of thousands. Therefore, it takes an enormous amount of labors to draw each line for the respective cables by using a device for generating a three dimensional model (three dimensional CAD data) such as a three dimensional arrangement adjusting CAD device. Moreover, determination of the cable route after the optimum route search is difficult to conduct in a short period of the designing stage.

### SUMMARY OF THE INVENTION

The present invention has been made in consideration of the circumstances mentioned above, and an object of the present invention is to provide a cable quantity totalizing device, a cable quantity totalizing method and a cable quantity totalizing program, with which an optimum cable route and the length of necessary cables are presented to a user in a more easily comprehensible way while the calculation precision for the cable length is ensured.

The above and other objects can be achieved according to the present invention by providing, in one aspect, a cable quantity totalizing device comprising;

an input unit configured to perform an inputting operation of information;

a memory unit as a database configured to store arrangement information and part identification information related to a three dimensional model of a contact point part having a contact point with a cable, arrangement information, part identification information and attribute information related to a three dimensional model of a cable container part for containing a cable when placed, cable specification information on the cable, and occupying rate information on the respective cable container parts;

a three dimensional model arrangement adjusting unit configured to arrange a three dimensional model in a three dimensional coordinate system obtained by simulating a space where a cable is actually placed;

a cable route search unit configured to read out the information on the cable container part stored in the database to search for a cable route with a shortest cable length;

a cable route calculation unit configured to calculate the cable length in the cable route searched for by the optimum cable route search unit; and

a display unit configured to display the cable route search result and the cable length calculation result.

In a preferred example of the above aspect, the three dimensional model arrangement adjusting unit may be configured to edit the three dimensional model data stored in the database, the three dimensional model arrangement information and the part identification information of the contact point, and the arrangement information, the part identification information and the attribute information related to the three dimensional model of the cable container part.

The optimum cable route search unit may be configured to perform a search for a cable route which meets a previously obtained search condition and has the shortest cable length, and the search condition is at least one of a proportion of a total cable area to a sectional area of the cable container part, a priority of the placing cable, and a priority of the cable container part used for cable placement.

It may be desired that the cable specification information at least includes identification of the cable, sectional area information, and part identification information on three dimensional models of contact point parts functioning as a start point and a goal point.

The optimum cable route search unit may be configured to set as an optimum route a cable route obtained by connecting a cable run intra-route obtained by sequentially searching for a start point of a cable, a terminal point of a cable container part closest to the terminal point of the cable container part closest to the goal point of the cable the start point of this cable, and terminal points of a cable container part closest to a goal point of the cable among terminal points adjacent to the terminal point of the cable container part closest to the start point of the cable, with terminal points of the cable container part closest to the goal point of the cable.

It may be desired that, in a case that there exists an overlap section in the cable run intra-route obtained by sequentially searching for terminal points of the container part closest to the goal point of the cable among terminal points adjacent to the terminal point of the cable container part closest to the start point of the cable and searching for the route to the terminal point of the cable container part closest to the goal point of the cable, the optimum cable route search unit is configured to delete the overlap section from the cable run intra-route.

The optimum cable route search unit may further include a cable list editing element having a function of editing a cable list and a log file which are output as a result of the cable quantity totalizing.

The display unit may be configured to receive image information indicating an arrangement state of the three dimensional model, image information indicating the search result, and image information indicating the calculation result so as to three dimensionally display the search result and the calculation result.

In another aspect of the present invention, there is also provided a cable quantity totalizing method comprising:

a part information obtaining step of obtaining arrangement information and part identification information related to a three dimensional model of a contact point part having a contact point with a cable, arrangement information, part identification information and attribute information related to a three dimensional model of a cable container part for containing a cable when placed, and cable specification information on the cable;

a search condition obtaining step of obtaining a search condition in a shortest cable route search;

a shortest cable route search step of searching for a shortest cable route under a condition obtained in the search condition obtaining step;

a cable length calculation step of calculating, when the shortest cable route is searched for in the shortest cable route search step, a length of the cable route searched for in the shortest cable route search step; and

a search result display step of displaying and outputting, when the shortest cable route is searched for in the shortest cable route search step, the shortest cable route and the cable length, and outputting, when the shortest cable route is not searched for in the shortest cable route search step, a message that the shortest cable route is not searched for.

In a further aspect of the present invention, there is also provided a cable quantity totalizing program for causing a computer to execute a cable quantity totalizing procedure which comprises:

a part information obtaining step of obtaining arrangement information and part identification information related to a three dimensional model of a contact point part having a contact point with a cable, arrangement information, part identification information and attribute information related to a three dimensional model of a cable container part for containing a cable when placed, and cable specification information on the cable;

a search condition obtaining step of obtaining a search condition in a shortest cable route search;

a shortest cable route search step of searching for a shortest cable route under a condition obtained in the search condition obtaining step;

a cable length calculation step of calculating, when the shortest cable route can be searched for in the shortest cable route search step, a length of the cable route searched for in the shortest cable route search step; and

a search result display step of displaying and outputting, when the shortest cable route can be searched for in the shortest cable route search step, the shortest cable route and the cable length, and outputting, when the shortest cable route cannot be searched for in the shortest cable route search step, a message that the shortest cable route cannot be searched for.

According to the present invention of the aspects mentioned above, the user can more easily perform the optimum cable route search and calculate the cable length on the basis of the search result.

In addition, the cable tray data necessary for the arrangement adjustment with respect to other parts is used, so the input of the cable three dimensional CAD data is unnecessary, thereby achieving high efficiency with use of the necessary minimum three dimensional CAD data generated by the three dimensional arrangement adjusting CAD devices.

Furthermore, the entire arrangement and specification information on the part contact points, which is a merit of the three dimensional arrangement adjusting CAD system, is used, whereby it is possible to attain more merits in that the search for the cable optimum route can be conducted in detail easily, and the cable quantity totalizing results from the cable route can be used for each stage of design, arrangement, and installation.

The nature and further characteristic features made clearer from the following descriptions made with reference to the accompanying drawings.

### BRIEF DESCRIPTION OF THE DRAWINGS

In the accompanying drawings:

FIG. 1 is a schematic diagram schematically showing a system configuration of a cable quantity totalizing device according to the present invention;

FIG. 2 is a schematic diagram showing an example in which an actual specification is simulated for an optimum cable route search to be performed by the cable quantity totalizing device according to the present invention;

FIGS. 3A to 3F are schematic diagrams showing examples of cable tray part models used for an optimum cable route search in the cable quantity totalizing device according to the present invention;

FIG. 4 is a process flow diagram for describing, in sequence, process steps of a cable quantity totalizing procedure performed as a cable quantity totalizing method according to the present invention;

FIG. 5 is a process flow diagram for describing, in sequence, detailed process steps of a shortest cable route search step of the cable quantity totalizing procedure performed as the cable quantity totalizing method according to the present invention;

FIG. 6 is an explanatory diagram for describing a result of the search in the example shown in FIG. 2 where optimum cable route search means performs a tentative cable run intra-route search step to search for a tentative cable run intra-route in the cable quantity totalizing device according to the present invention;

FIG. 7 is an explanatory diagram for describing a result of a formalized cable run intra-route determination step performed by the optimum cable route search means of the cable quantity totalizing device according to the present invention with respect to the tentative cable run intra-route shown in FIG. 6;

FIG. 8 is an explanatory diagram showing a data structure example of a cable tray DB recorded and stored in recording means of the cable quantity totalizing device according to the present invention;

FIG. 9 is an explanatory diagram showing a data structure example of a cable list recorded and stored in recording means of the cable quantity totalizing device according to the present invention;

FIG. 10 is an explanatory diagram showing examples of a shortest cable route search result and a cable length calculation result displayed on display means at the time of a search result display step in the cable quantity totalizing procedure performed by the cable quantity totalizing device according to the present invention; and

FIG. 11 is a schematic diagram showing another embodiment of the cable quantity totalizing device according to the present invention.

### DESCRIPTION OF THE PREFERRED EMBODIMENTS

Hereinafter, a best mode for carrying out the present invention will be described with reference to the drawings.

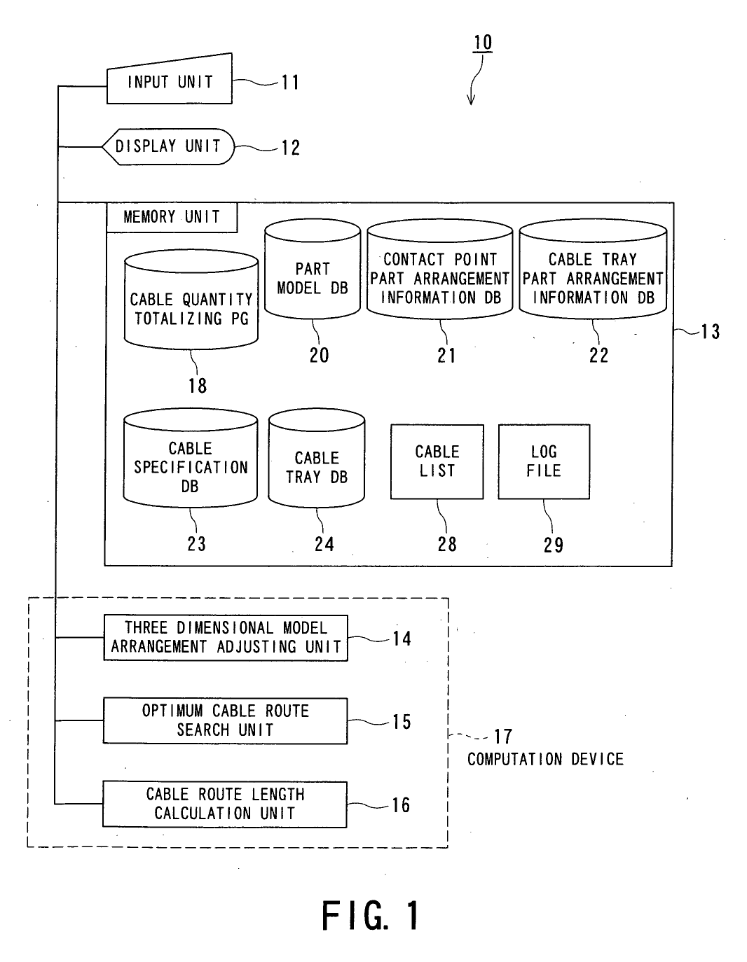

With reference to FIG. 1 showing one embodiment of the present invention, a cable quantity totalizing device 10 includes input means 11 for allowing a user to input information, display means 12 for receiving a display request and displaying information related to the received display request on a screen, memory means 13 capable of storing electronic data, three dimensional model arrangement adjusting means 14 for three-dimensionally displaying a previously generated three dimensional model to enable position adjustment, optimum cable route search means 15 for searching for a cable route with the shortest cable length (hereinafter, referred to as optimum cable route) on the basis of a previously obtained search condition, and a computation device 17 for realizing, through calculation, a function of cable route length calculation means 16 for calculating the cable length in the optimum cable route searched for by the cable route search means 15.

The cable quantity totalizing device 10 is realized by a computer function as hardware (not shown in the drawing) and a program function as software (hereinafter, abbreviated as PG) in corporation with each other. To be more specific, the cable quantity totalizing device 10 is realized in such a manner that a cable quantity totalizing PG 18 for searching for the optimum cable route and calculating the cable length in the searched optimum cable route is previously installed in the computer, and the computer then executes the cable quantity totalizing PG 18.

In the cable quantity totalizing device 10, the input means 11 is a man-machine interface, which is used when a user inputs information to the cable quantity totalizing device 10. Then, a graphical user interface (GUI) is introduced to the cable quantity totalizing device 10, which facilitates arrangement and movement operations for a three dimensional model and the like as described later.

The display means 12 can receive image information from three dimensional model arrangement adjusting means 14, the optimum cable route search means 15, or the cable route length calculation means 16, and display an image based on the received image information on a display surface.

The memory means 13 is an area where read, record, delete, and storage or like operation of electronic data can be conducted, and the memory means 13 can store and save an electronic file, the PG, database (hereinafter, abbreviated as DB).

The cable quantity totalizing PG 18 is stored in the memory means 13, and at the same time, as the DB, a part model DB 20, a contact point part arrangement information DB 21, a cable tray part arrangement information DB 22 as a cable storage part arrangement information DB, a cable specification DB 23, and a cable tray DB 24 are previously stored in the memory means 13.

The part model DB 20 is a DB for storing data for displaying a three dimensional model (hereinafter, referred to as three dimensional model data) previously generated by a three dimensional CAD arrangement adjusting device or the like on the display means 12.

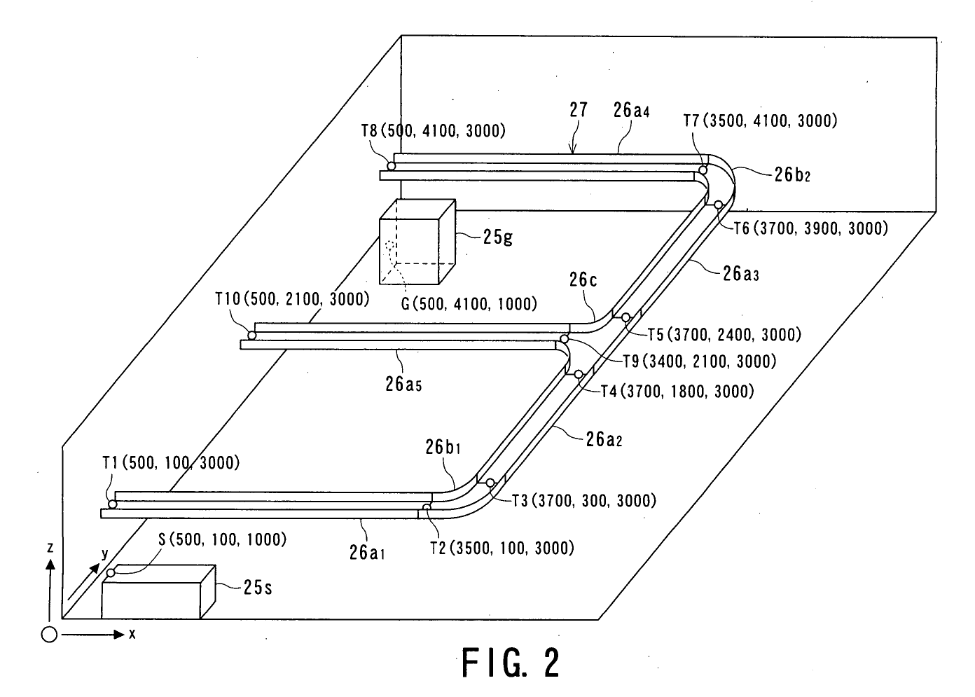

The contact point part arrangement information DB 21 is a DB for storing arrangement information on three dimensional models 25 (255 and 259 in FIG. 2) of parts such as an electric device and a distribution board shown in FIG. 2 to be connected with a cable. It should be noted that the parts such as the electric device and the distribution board to be connected with the cable are hereinafter referred to as contact point parts, and three dimensional models of the contact point parts are hereinafter referred to as contact point part models.

Herein, the arrangement information on the contact part model 25 is contact point coordinate information, as shown in FIG. 2, formed of a three dimensional coordinate point where the contact point part is connected to the cable, that is, three dimensional coordinate point information in the width direction (the x-axis direction), the depth direction (the y-axis direction), and the height direction (the z-axis direction) with a certain position (origin “O”) as a reference.

In addition, for example, part identification information such as identification numbers are respectively assigned to the contact part models 25 to have uniqueness at the time of the model generation. The part identification information is also stored along with the arrangement information in the contact point part arrangement information DB 21. Therefore, on the basis of the part identification information and the arrangement information (hereinafter, referred to as model identification arrangement information), the one and single position of the contact part model 25 can be identified three-dimensionally.

The cable tray part arrangement information DB 22 is a DB for storing the arrangement information, the part identification information and attribute information on a three dimensional model 26 (26a₁, . . . , 26a₅, 26b₁, 26b₂, and 26c) of the cable tray part (hereinafter, referred to as cable tray part model) as a cable container part for containing the cable to be placed as shown in FIG. 2.

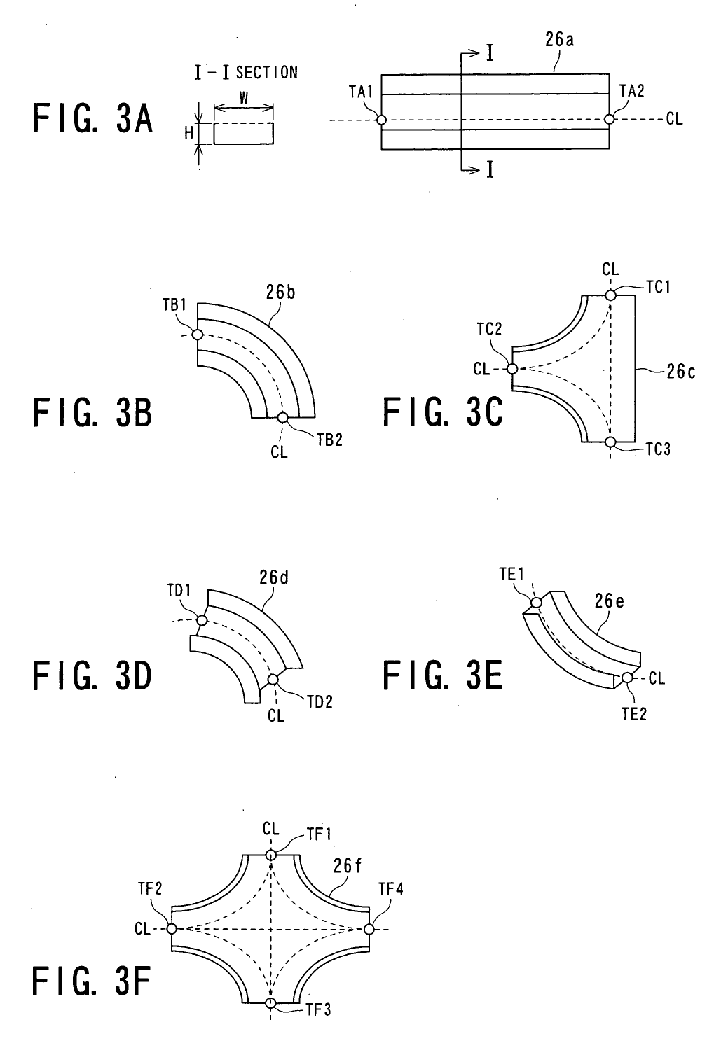

Herein, the arrangement information on the cable tray part is three dimensional coordination information having auxiliary points, not shown in the drawing, for identifying the contact points contacting other cable tray parts and shape. Then, the contact points of the cable tray part denote points T (TA₁, . . . , TF₄) shown in FIGS. 3A to 3F, which are on joint surfaces of other cable tray parts and intersection points with a center line CL passing through the center of a tray width W. Therefore, in FIG. 2, points corresponding to T1 to T10 of the cable tray part model 26 (26a₁, . . . , 26a₅, 26b₁, 26b₂, and 26c) are terminal points of the cable tray part models 26.

The arrangement information on the cable tray part has plural pieces of three dimensional coordination information, but the number of three dimensional coordination information provided as information differs in shape. For example, the cable tray part models of a straight shape (hereinafter, straight type cable tray part model) 26a₁ to 26a₅ shown in FIG. 3A have two pieces of terminal point coordinate information. In case of cable tray part models 26b₁ and 26b₂ of a circular arc shape (hereinafter, referred to as circular arc type cable tray part model), there are three pieces of dimensional coordination information for the reason that, in addition to coordinate information on two terminal points, one piece of coordinate information on the auxiliary point for identifying the center angle and the curvature radius is necessary. A T-shaped cable tray part model 26c has one more piece of the terminal point coordinate information than the circular arc type cable tray part models 26b₁ and 26b₂.

Meanwhile, the part identification information on the cable tray part model 26 is information such as identification numbers to be respectively assigned to have uniqueness, for example. On the other hand, the attribute information is information assigned to identify the shape of the cable tray part model 26. For example, in the example shown in FIGS. 3A to 3F, the information is to identify the cable tray part model 26 corresponding to which of the cable tray part models 26a to 26f in FIGS. 3A to 3F. Then, the attribute information is also used for the cable length calculation.

The arrangement information, the part identification information, and the attribute information on the cable tray part model 26 are stored in the cable tray part arrangement information DB 22. Then, also regarding the cable tray part models 26, similarly to the contact part model 25, only the position of the cable tray part model 26 can be identified three dimensionally on the basis of the part identification information and the arrangement information stored in the cable tray part arrangement information DB 22, that is, model identification arrangement information.

It should be noted that the cable tray part model 26 does not necessarily need to have the part identification information. This is because if each terminal point has identification information as the arrangement information, by following the terminal points to be passed by the cable, the optimum cable route can be searched. Then, this is because if a branch ID is assigned at a path branch position of a cable run part model 27 composed of combining the cable tray part models 26, it is possible to follow the passing branch of the cable optimum route later.

The cable specification DB 23 includes at least the part identification information on cable identification information (for example, an identification number), cross sectional information, a contact point part model functioning as a start point (hereinafter, referred to as start point model) 255, and a contact point part model functioning as a goal point (hereinafter, referred to as goal point model) 259 as cable specification information.

Herein, cross sectional information is information to calculate the finishing cross section area, which includes indirect information. That is, cross sectional information includes not only the value of the finishing cross section area but also the diameter or radius of the cable.

It should be noted that, for example, information such as the application, voltage, and supplier may be appropriately added to the cable specification information. Moreover, the cable specification information may further include the placing priority information defining the placing cable priority (hereinafter, referred to as placing priority) and information on an upper limit value of the occupying rate to be described later.

In cable tray DB 24, information on the occupying rate of each cable tray (hereinafter, referred to as occupying rate information) is recorded and stored. Herein, the occupying rate is an index showing how much the cable placed in the cable tray occupies with respect to the total volume of the cable tray. In other words, when the cable is placed, how much the total sum of the respective cable cross sectional areas occupies with respect to the cable tray cross sectional area in a direction perpendicular to the cable placement direction (in the cross sectional view taken along the I-I line shown in FIG. 3A, the area corresponding to W×H).

Furthermore, in the memory means 13, regarding the optimum cable route search result as well, a cable list 28 or the like can be recorded or stored as electronic data, etc.

The cable list 28 has information on a cable name, a necessary cable length and a route for placing the cable as the optimum cable route search result, as shown in FIG. 9, to every cable unit.

The three dimensional model arrangement adjusting means 14 reads the three dimensional model data from the part model DB 20, and has a function of arranging the three dimensional model represented by the three dimensional model data placed in a three dimensional coordination system obtained by simulating a space where the cable is actually placed (three dimensional model arrangement function) and also has a function of performing position arrangement on the three arranged dimensional models (three dimensional model position arrangement function). The three dimensional model arrangement adjusting means is processing means for three dimensionally arranging the three dimensional model previously generated by a three dimensional arrangement adjusting CAD device and also performing position arrangement of the arranged three dimensional models.

In addition, the three dimensional model arrangement adjusting means 14 has a function of editing the model identification arrangement information on the three dimensional model such as the contact part model 25 and the cable tray part model 26 (model identification arrangement information editing function). The edited information on the model identification arrangement information on the contact part model 25 can be stored in the contact point part arrangement information DB 21 and the edited information on the model identification arrangement information on the cable tray part model 26 can be stored in the cable tray part arrangement information DB 22.

The optimum cable route search means 15 has a function of searching for a shortest cable route under a certain condition requested by the user, that is, has a function of searching for the optimum cable route (optimum cable route searching function). The optimum cable route search means is processing means for searching for the optimum cable route.

Then, the optimum cable route search means 15 has a function of deleting, when the searched cable route has an overlap section, the overlap section (cable route overlap detection function). That is, when the cable route obtained for the first time has an overlap section, a new cable route having the overlapped cable route deleted can be obtained as the optimum cable route.

Furthermore, the optimum cable route search means 15 can temporarily store the cable route search progress and the search result such as coordinate information on a terminal point where the cable passes, the passing order, and part identification information on the cable tray part model 26 where the cable is placed.

The cable route length calculation means 16 has a function of obtaining coordinate information on the terminal point on the optimum cable route searched for by the optimum cable route search means 15 and calculating the length of the optimum cable route (cable length calculation function). That is, the cable route length calculation means 16 is processing means for calculating the length of the optimum cable route searched for by the optimum cable route search means 15.

A cable quantity totalizing PG 18 is a PG for causing a computer to function as the three dimensional model arrangement adjusting means 14, the optimum cable route search means 15, and the cable route length calculation means 16. As the cable quantity totalizing PG 18 is executed by the computer, the computer can have the three dimensional model arrangement function, the three dimensional model position arrangement function, the optimum cable route searching function, and the cable length calculation function.

In the thus structured cable quantity totalizing device 10, the cable run part model 27, such as the cable tray whose number of the parts is smaller than that of the cables and which significantly affects the cable route, is used. Therefore, without decrease in the calculation accuracy as compared with the prior art, the search of the optimum cable route and the route length (quantity totalizing) can be conducted.

Further, the three dimensional CAD data necessary for the search may only have one on parts functioning as the start point and the goal point and one on the cable tray part. Thus, when the necessary contact part, the cable tray part, the position of each part, and usable cable are determined, a search for the optimum cable route using the three dimensional model already generated by the three dimensional arrangement adjusting CAD device can be performed. Furthermore, the load of the three dimensional CAD data generation is only necessary minimum, which is efficient.

Furthermore, with the use of the three dimensional data, the search result (the optimum cable route) is three dimensionally displayed, and the user can recognize the optimum cable route in a three dimensionally manner, so the optimum cable route can be presented to the user in a more comprehensive way as compared with the prior art.

Meanwhile, the cable list 28 generated as the cable quantity result can be output as a cable arrangement ledger sheet, which can be used for the cable design down stream development. Then, terminal points through which the cable passes are described in sequence in the cable list 28, which can be thus used as an installation instruction material and an instruction ledger sheet in the cable placement.

It should be noted that the part model DB 20, the contact point part arrangement information DB 21, the cable tray part arrangement information DB 22, the cable specification DB 23, and the cable tray DB 24 should not necessarily be a DB. As long as necessary information is stored, the DB may be an electronic file.

Further, the part model DB 20, the contact point part arrangement information DB 21, the cable tray part arrangement information DB 22, the cable specification DB 23, and the cable tray DB 24 may be further divided or formed of a combination of some DBs. As a result, it suffices that necessary minimum information stored in the part model DB 20, the contact point part arrangement information DB 21, the cable tray part arrangement information DB 22, the cable specification DB 23, and the cable tray DB 24 are stored in a DB.

Furthermore, the electronic data stored in the memory means 13 may be stored in other recording medium accessible from the cable quantity totalizing device 10 (irrespective of the inside or outside of the cable quantity totalizing device 10).

Meanwhile, the cable quantity totalizing device 10 may further include DB editing means having a function of editing the information stored in the DB (the part model DB 20, the contact point part arrangement information DB 21, the cable tray part arrangement information DB 22, the cable specification DB 23, and the cable tray DB 24).

In addition, the cable quantity totalizing device 10 may further include cable list editing means and log file editing means having a function of editing the cable list 28 and a log file 29 which are output as the cable quantity totalizing result, that is, the optimum cable route search result and the optimum cable route length calculation. Because of the reason that the cable quantity totalizing device further includes the cable list editing means, the cable quantity totalizing device 10 can edit the cable list 28 to generate a ledger sheet about each cable.

Next, the cable quantity totalizing method according to the present invention will be described.

In the cable quantity totalizing method according to the present invention, the actual part arrangement is simulated by using the three dimensional model already generated by the three dimensional arrangement adjusting CAD device, and in the simulated three dimensional model arrangement, the cable route with the shortest cable length while meeting a certain condition requested by the user, that is, the optimum cable route is searched for. Then, the cable length of the thus obtained optimum cable route is calculated, and the optimum cable route search result and the cable length calculation result are presented to the user. That is, the cable quantity totalizing method according to the present invention includes a search method for the optimum cable route and a calculation method for the length of the optimum cable route.

FIG. 2 is a schematic diagram for describing a case where the optimum cable route is searched for, which shows an example of simulating the actual specification by using the three dimensional model. FIGS. 3A to 3F are schematic diagrams showing examples of the cable tray part model 26.

In the example shown in FIG. 2, the contact part model 25 (the start point model 25s and the goal point model 25g) and the cable tray part model 26 are arranged to simulate the actual layout. Herein, one scale (basic unit) of the coordinate is based on “mm”. That is, “2 m” in actuality represents “2000” in the coordinate system shown in FIG. 2.

Further, the cable tray part model 26 prepares various cable tray part models 26a to 26f different in shape shown in, for example, FIGS. 3A to 3F, so that the cable is placed in various spaces.

In the example shown in FIG. 2, among the cable tray part models 26a to 26f shown in FIGS. 3A to 3F, five straight type cable tray part models 26a, two circular arc type cable tray part models 26b, and one T-shaped cable tray part model (hereinafter, T shape type cable tray part model) 26c are arranged to form the cable run part model 27.

It should be noted that in FIG. 2, in order to identify the file straight type cable tray part models 26a, the straight type cable tray part model 26a having the terminal points T1 and T2 is set as the first straight type cable tray part model 26a₁.

Similarly, the straight type cable tray part model 26a having the terminal points T3 and T4 is set as the second straight type cable tray part model 26a₂, the straight type cable tray part model 26a having the terminal points T5 and T6 is set as the third straight type cable tray part model 26a₃, the straight type cable tray part model 26a having the terminal points T7 and T8 is set as the fourth straight type cable tray part model 26a₄, and the straight type cable tray part model 26a having the terminal points T9 and T10 is set as the fifth straight type cable tray part model 26a₅.

Meanwhile, regarding the two circular arc type cable tray part models 26b as well, similarly, the first circular arc type cable tray part model 26b₁ has the terminal points T2 and T3 and the second circular arc type cable tray part model 26b₂ has the terminal points T6 and T7.

Then, the terminal point T2 to the terminal point T7 are common terminal point for both the cable tray part models 26. For example, the terminal point T2 is a common terminal point for the terminal point in the first straight type cable tray part model 26a₁ (corresponding to TA2 shown in FIG. 3A) and the terminal point in the first circular arc type cable tray part model 26b₂ (corresponding to TB2 shown in FIG. 3B).

In order to perform the optimum cable route search method according to the present invention, such a structure is necessary that the three dimensional model arrangement adjusting means 14 receiving the positioning request from the user performs positioning on the contact part model 25 and the cable tray part model 26, for example, as shown in FIG. 2, which are respectively simulating the contact point part and the cable tray part, and the optimum cable route search means 15 executes a processing step for receiving a search condition input from the user (preparation step).

Then, in order to execute this preparation step, the contact point part arrangement information DB 21, the cable tray part arrangement information DB 22, and the cable specification DB 23 need to be structured to store the arrangement information and the part identification information on the contact part model 25, the arrangement information, the part identification information, and the attribute information on the cable tray part model 26, and cable specification information on the placing cable in the DB.

In order to store the arrangement information and the part identification information on the contact part model 25 (the start point model 25s and the goal point model 25g) in the contact point part arrangement information DB 21, firstly, the user inputs a contact point model display request through the input means 11 to display the contact part model 25 on the display means 12.

That is, in the example shown in FIG. 2, the computation device 17 receiving the contact point part model display request from the user causes the three dimensional model arrangement adjusting means 14 to function. Then, the three dimensional model arrangement adjusting means 14 reads the start point model 25s and the goal point model 25g from the part model DB 20 to thereby display the start point model 25s and the goal point model 25g on the display means 12.

Subsequently, when the start point model 25s and the goal point model 25g are displayed on the display means 12, through the inputting operation by the user, the start point model 25s and the goal point model 25g are arranged at appropriate positions for positioning. Once the positioning is completed, the user inputs, through the input means 11, a save request for the arrangement information and the part identification information on the contact part model 25 (the start point model 25s and the goal point model 25g).

When the save request input through the input means 11 is received by the computation device 17, the computation device 17 causes the three dimensional model arrangement adjusting means 14 to function, thereby causing the three dimensional model arrangement adjusting means 14 to execute a save processing for the contact part model 25. That is, the three dimensional model arrangement adjusting means 14 stores the arrangement information on the contact part model 25 and the part identification information in the contact point part arrangement information DB 21.

The arrangement information, the part identification information, and the attribute information on the cable tray part model 26 can be also recorded and stored in the cable tray part arrangement information DB 22 in a similar procedure of that for the arrangement information, the part identification information, and attribute information on the contact part model 25. It should be noted that the arrangement of the cable tray part model 26 needs to be performed, for example, while paying attention not to cause interference with other three dimensional model such as the arrangement model.

The cable specification information on the placing cable is saved and stored in the previously structured cable specification DB 23. Herein, identification information for identifying the cable is described in a cable A, a cable B, etc.

It should be noted that the cable specification information is assumed to be stored in the cable specification DB 23, but may be stored in a data file. Then, any data file format can be used as long as the optimum cable route search means 15 can read the data file.

For example, by using a database format file, the cable specification information may be recoded and saved, or by using a spread sheet format file, the cable specification information may be recoded and saved. This spread sheet format file is flexible and can be used even without knowing a specific search language. Thus, the spread sheet format file is widely used as an engineering tool and is more advantageous to the database format file.

After the information necessary for the search has been stored in the DB, as the preparation step, the three dimensional model arrangement adjusting means 14 receiving the positioning request from the user performs, for example, as shown in FIG. 2, positioning on the contact part model 25 and the cable tray part model 26 which are respectively simulating the contact point part and the cable tray part, and the optimum cable route search means 15 accepts the search condition input by the user.

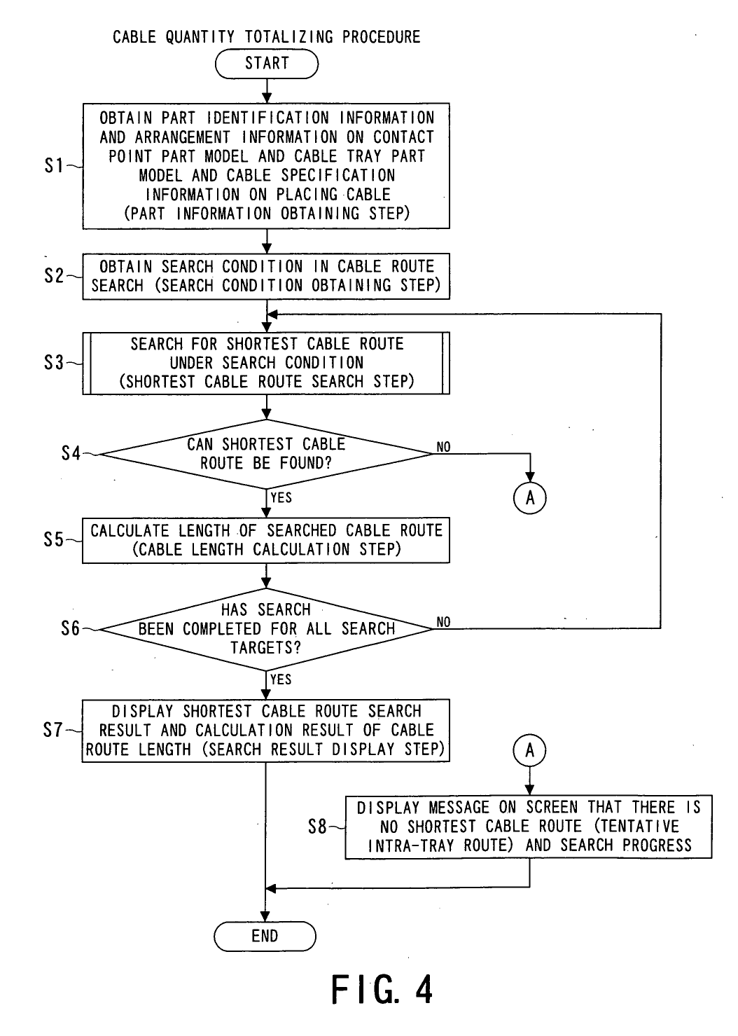

In a state where such a preparation step is completed, when the user inputs a start request for the cable quantity totalizing process through the input means 11, the computation device 17 receives the input cable quantity totalizing process start request to start a cable quantity totalizing procedure of FIG. 4 (START). As the cable quantity totalizing device 10 executes the cable quantity totalizing procedure, the cable quantity totalizing method according to the present invention can be conducted.

FIG. 4 is a process flow diagram for describing, in sequence, process steps of the cable quantity totalizing procedure. It should be noted that in the following description on the cable quantity totalizing procedure, the cable quantity totalizing in the case of placing the cable A is assumed in the layout shown in FIG. 2.

The cable quantity totalizing procedure includes: a part information obtaining step (Step S1) of obtaining the part identification information and the arrangement information on the contact part model 25 and the cable tray part model 26 and the cable specification information on the placing cable; a search condition obtaining step (Step S2) of obtaining a search condition in the shortest cable route search at that time; a shortest cable route search step (Step S3) of searching for a shortest cable route obtained in the search condition obtaining step S2; a cable length calculation step (Step S5) of calculating the cable route length of the shortest cable route search step searched for in Step S3 under the condition where the shortest cable route can be searched for in the shortest cable route search step S3 (in the case of “YES” in Step S4); an all search target search completion confirmation step (Step S6) for confirming whether or not the shortest cable route search and the cable length calculation are completed for all the cables as the route search targets; and a search result display step of displaying and outputting (Step S7) the shortest cable route and the cable length calculated in the cable length calculation step S5 when the shortest cable route can be searched for in the shortest cable route search step S3 (in the case of “YES” in Step S4) and on the other hand when the shortest cable route cannot be found in the shortest cable route search step (in the case of NO in Step S4), displaying and outputting (Step S8) a message that the shortest cable route cannot be found.

When the cable quantity totalizing procedure is stated, firstly, the flow proceeds to Step S1. In Step S1, the optimum cable route search means 15 obtains the part identification information and the arrangement information on the contact part model 25 and the cable tray part model 26 and the cable specification information on the placing cable from the contact point part arrangement information DB 21, the cable tray part arrangement information DB 22 and the cable specification DB 23, and upon completion of obtaining all the information, the part information obtaining step S1 has been completed.

When the part information obtaining step S1 has been completed, subsequently, in Step S2, the optimum cable route search means 15 receives the information input by the user or reads the information stored in the DB so as to obtain the search condition at the time of the shortest cable route search.

Examples of the search condition at the time of the shortest cable route search include the occupying rate, the placing priority, the cable tray priority (the tray priority) used for placing the cable, etc. It should be noted that the search condition includes an unstinting condition where no condition is set.

When the optimum cable route search means 15 obtains the search condition such as the occupying rate, the search condition obtaining step in Step S2 has been completed, and subsequently, the flow advances to Step S3. Then, in Step S3, the shortest cable route search step is performed.

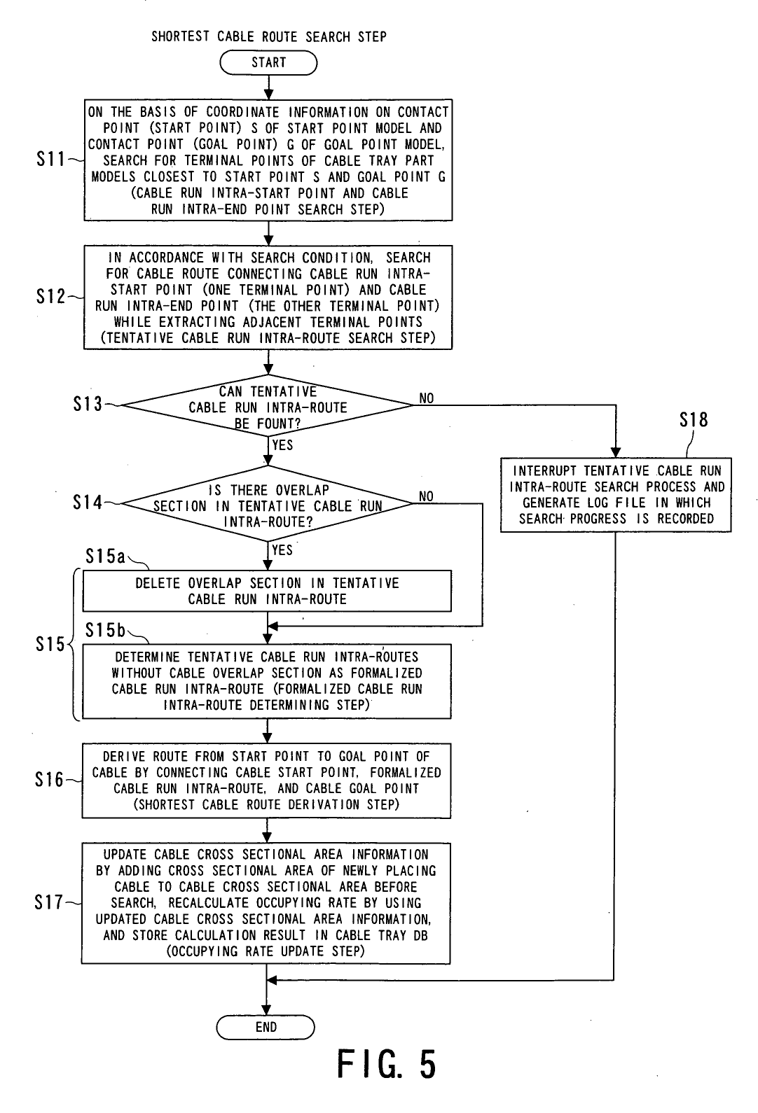

FIG. 5 is a process flow diagram for describing, in sequence, detailed process steps of the shortest cable route search step S3 in the cable quantity totalizing procedure.

The shortest cable route search step S3 includes: a cable run intra-start point and goal point search step (Step S11) of searching for the contact points of the cable tray part in the shortest distance to the start point of the cable (hereinafter, referred to as cable run intra-start point) and the contact points of the cable tray part in the shortest distance to the goal point of the cable (hereinafter, referred to as cable run intra-goal point); a tentative cable run intra-route search step (Step S12) of searching for a cable run intra-route connecting the cable run intra-start point and the cable run intra-goal point searched for by the cable run intra-start point and goal point search step while extracting adjacent terminal points to search for a tentative cable run intra-route (hereinafter, referred to as tentative cable run intra-route); a step of confirming (Step S13) whether or not the tentative cable run intra-route can be searched for in the tentative cable run intra-route search step; a step of confirming (Step S14) whether or not there is a cable overlap section in the tentative cable run intra-route when it is confirmed in this Step S13 that the tentative cable run intra-route exists (in the case of “YES” in Step S13); a step of deleting (Step S15a) the overlap section from the tentative cable run intra-route searched for in Step S14 when the cable overlap section exists (in the case of YES in Step S14); a formalized cable run intra-route determination step (Step S15b) of setting the tentative cable run intra-route as a formalized cable run intra-route (hereinafter, referred to as formalized cable run intra-route) when the result of Step S15a is accepted and no cable overlap section exists (in the case of NO in Step S14); a derivation step (Step S16) of deriving a shortest cable route from the start point of the cable to the goal point of the cable by connecting the start point of the cable, the cable run intra-start point, the formalized cable run intra-route, the cable run intra-goal point, and the goal point of the cable; an occupying rate update step (Step S17) of calculating the sum of the cross sectional areas of the respective cables placed in each the cable tray part on the basis of the search result in the formalized cable run intra-route to update the occupying rate; and a step of interrupting (Step S18) the tentative cable run intra-route search process and generating the log file 29 in which the search result is recorded (Step S18) when the existence of the tentative cable run intra-route cannot be confirmed (NO in Step S13).

Subsequently, in FIG. 5, when the shortest cable route search step (Steps S11 to S17) is started, firstly, the flow advances to Step S11. In Step S11, the cable run intra-start point and goal point search step is performed.

In the cable run intra-start point and goal point search step (Step S11), the optimum cable route search means 15, firstly, searches for terminal points of the cable tray part model 26 respectively closest to the contact point of the start point model 25s and the contact point of the goal point model 25g thus obtained, that is, the start point S (500 in the x-axis positive direction, 100 in the y-axis positive direction, and 1000 in the z-axis positive direction from the origin “O” (0, 0, 0) are denoted by (500, 100, 1000) and the same applies hereinafter) and the goal point G (500, 4100, 1000) as shown in FIG. 2.

The terminal point search uses coordinate information. Herein, the coordinate information is, for example, a coordinate in the rectangular coordinate system (x, y, z) where three axes of the x-axis, the y-axis, and the z-axis are at right angles to each other as shown in FIG. 2, that is, numeral value information on x, y and z. It should be noted that in this embodiment, the example has been described in which the rectangular coordinate system is used as the coordinate information, but coordinate information based on other coordinate system (for example, the rotational coordinate system) may be used.

In the case of the example shown in FIG. 2, the optimum cable route search means 15 searches, from the part identification information and the arrangement information on the cable tray part model 26, for the terminal points closest to the start point S (500, 100, 1000) (the cable run intra-start point), and obtains coordinate information on the terminal point T1 (500, 100, 3000) close to the start point S. Then, the terminal points closest to the goal point G (500, 4100, 1000) (the cable run intra-goal point), that is, coordinate information on the terminal point T8 (500, 4100, 3000) are similarly obtained.

When the optimum cable route search means 15 searches for the cable run intra-start point and the cable run intra-goal point and obtains coordinate information on the cable run intra-start point and the cable run intra-goal point, the cable run intra-start point and goal point search step is completed, subsequently, the tentative cable run intra-route search step is performed in Step S12.

In the tentative cable run intra-route search step (Step S12), while following the search condition, the optimum cable route search means 15 searches for a cable route connecting one terminal point of the cable run intra-start point and the cable run intra-goal point to the other terminal point while extracting adjacent terminal points.

For example, if the optimum cable route search means 15 performs the cable route search from the cable run intra-start point towards the cable run intra-goal point, terminal points closest to the terminal point T8 functioning as the cable run intra-goal point are searched for. Subsequently, among the searched terminals and the adjacent terminals, the terminal point closest to the terminal point T8 is searched for. Such a search is repeatedly performed until reaching the terminal point T8.

However, when the search condition has more constraints, while obeying the search condition, the terminal point closest to the cable run intra-goal point T8 is searched for. It should be noted that, in the example shown in FIG. 2, there is described no constraints on the upper limit value of the occupying rate, setting for the passing cable tray, or the like.

To be more specific, firstly, when the coordinate information on the terminal point T1 is obtained, and subsequently, the optimum cable route search means 15 identifies the cable tray part model 26 having the terminal point T1. In the example shown in FIG. 2, the cable tray part model 26 having the terminal point T1 is the first straight type cable tray part model 26a₁.

When the first straight type cable tray part model 26a₁ having the terminal point T1 is identified, and subsequently, the optimum cable route search means 15 searches for terminal points other than the terminal point T1 among the first straight type cable tray part model 26a, as the next passing terminal point. Herein, the terminal point T2 is selected, and the optimum cable route search means 15 obtains coordinate information on the terminal point T2 (3500, 100, 3000) as the next passing terminal point.

Subsequently, the optimum cable route search means 15 identifies the cable tray part model 26 other than the first straight type cable tray part model 26a₁ among the cable tray part models 26 having the selected terminal point T2. In the example shown in FIG. 2, the cable tray part model 26 having the terminal point T2 as the terminal point is the first straight type cable tray part model 26a₁ and the first circular arc type cable tray part model 26b₁, so that the first circular arc type cable tray part model 26b₁ is identified.

Subsequently, the optimum cable route search means 15 judges the first circular arc type cable tray part model 26b₁ as the next passing cable tray part model 26. Then, among the terminal points of the first circular arc type cable tray part model 26b₁, as the next passing terminal point, the terminal points other than the terminal point T2, that is, the terminal point T3 is selected. Then, the optimum cable route search means 15 obtains coordinate information on the terminal point T3 (3700, 300, 3000) as the next passing terminal point.

Likely, hereinafter, the terminal points T through which the cable passes are obtained. As shown in FIG. 2, the cable route from the terminal point T1 to the terminal point T4 is only one route. As a result, the cable route from the terminal point T1 to the terminal point T4 is obtained. That is, the following route “the start point S→the terminal point T1→the terminal point T2→the terminal point T3→the terminal point T4” is searched for.

Subsequently, among the terminal points of the T shape type cable tray part model 26c having the terminal point T4 as the terminal point, the terminal points other than the terminal point T4 are searched for. As a result, two terminal points of the terminal point T9 and the terminal point T5 are detected. As for the selection between the two terminal points, although depending on the content of the search condition, if there is no constraint of the occupying rate, the terminal point T closest in the direct distance to the destination terminal point T8 is selected.

In the example shown in FIG. 2, the optimum cable route search means 15 compares the distance of the terminal point T5 between the terminal point T8 with the distance of the terminal point T9 between the terminal point T8, and selects the terminal point T9 at a shorter distance as the next terminal point of the terminal point T4. Then, when the optimum cable route search means 15 obtains coordinate information on the terminal point T9 (3400, 2100, 3000), subsequently, among the cable tray part models 26 having the selected terminal point T9 as the terminal point, the cable tray part model 26 other than the T shape type cable tray part model 26c is identified.

In the example shown in FIG. 2, the cable tray part model 26 having the terminal point T9 is the T-shape type cable tray part model 26c and the fifth straight type cable tray part model 26a₅, so that the fifth straight type cable tray part model 26a₅ is identified.

Subsequently, the optimum cable route search means 15 judges the fifth straight type cable tray part model 26a₅ as the next passing cable tray part model 26, selects the terminal point other than the terminal point T9 among the terminal points of the fifth straight type cable tray part model 26a₅ as the next passing terminal point, i.e., the terminal point T10, and obtains coordinate information on the terminal point T10 (500, 2100, 3000).

Subsequently, the optimum cable route search means 15 identifies the cable tray part model 26 other than the fifth straight type cable tray part model 26a₅ among the cable tray part models 26 having the selected terminal point T10 as the terminal point. However, in the example shown in FIG. 2, no other cable tray part model 26 having the terminal point T10 as the terminal point exists. In this way, if there is no other cable tray part model 26, it is judged that another route is necessary, and the route returns to the previous terminal point T9.

When the route returns to the terminal point T9 again, the optimum cable route search means 15 identifies the cable tray part model 26 other than the fifth straight type cable tray part model 26a₅ having the terminal point T9. Herein, the T-shape type cable tray part model 26c is identified. Then, the terminal point other than the terminal point T9 of the T-shape type cable tray part model 26c, that is, between the terminal point T4 and the terminal point T5, the terminal point T5 closer to the terminal point T8 is selected as the next terminal point. Then, the optimum cable route search means 15 obtains coordinate information on the terminal point T5 (3700, 2400, 3000). The same applies hereinafter, and the cable passing terminal points T are detected.

FIG. 6 is an explanatory diagram showing a result of the search for the tentative cable run intra-route while the optimum cable route search means 15 executes the tentative cable run intra-route search step in the example shown in FIG. 2. It should be noted that FIG. 6 shows a plan view of the cable tray part model 26 shown in FIG. 2 for simplicity of the drawing.

When the optimum cable route search means 15 performs the tentative cable run intra-route search step, as shown in FIG. 6, “the terminal point T1→the terminal point T2→the terminal point T3→the terminal point T4→the terminal point T9→the terminal point T10 the terminal point T9→the terminal point T5→the terminal point T6→the terminal point T7→the terminal point T8” is searched for as the tentative cable run intra-route. In this way, when the optimum cable route search means 15 searches for the tentative cable run intra-route, the tentative cable run intra-route search step is completed.

When the tentative cable run intra-route search step is completed, and subsequently, in Step S13, the optimum cable route search means 15 confirms whether or not the tentative cable run intra-route can be searched for, that is, confirms the presence or absence of the tentative cable run intra-route. Then, as shown in FIG. 6, when the tentative cable run intra-route exists (in the case of “YES” in Step S13), the flow proceeds to Step S14. In Step S14, the optimum cable route search means 15 confirms whether or not there is an overlap section in the tentative cable run intra-route where the cables are overlapped.

As shown in FIG. 6, when the tentative cable run intra-route has the cable overlap section (in the case of “YES” in Step S14), the flow proceeds to Step S15. In Step S15, the optimum cable route search means 15 deletes the cable overlap section in the tentative cable run intra-route. A more specific description is given by using the tentative cable run intra-route shown in FIG. 6. In the tentative cable run intra-route, as there is an overlap of the cable route between the terminal point T9 and the terminal point T10, a section “the terminal point T9→the terminal point T10→the terminal point T9”, that is, the cable route overlap section is deleted.

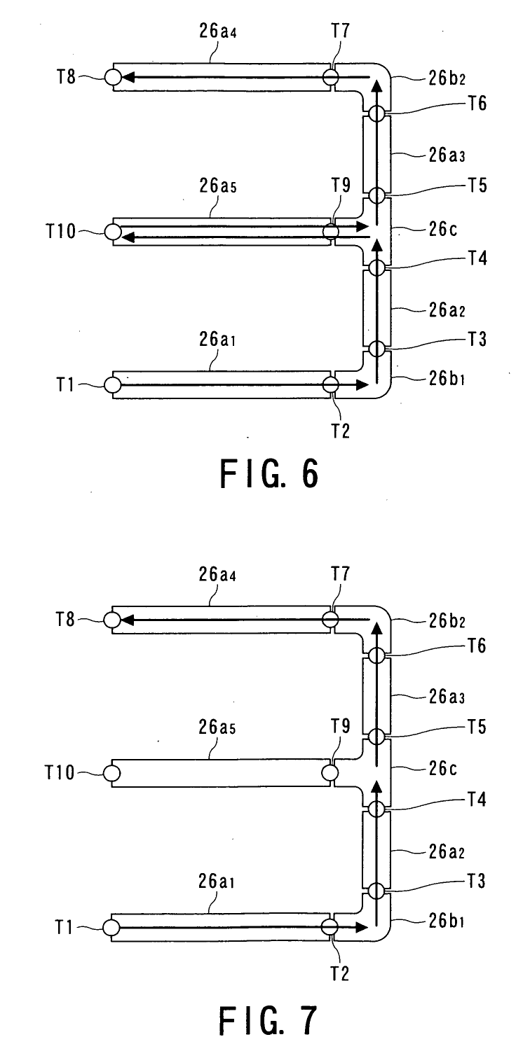

FIG. 7 is an explanatory diagram for describing a result of a formalized cable run intra-route determination step performed on the tentative cable run intra-route shown in FIG. 6.

As shown in FIG. 7, as a result of the formalized cable run intra-route determination step, the tentative cable run intra-route shown in FIG. 6 is as follows “the terminal point T1 →the terminal point T2→the terminal point T3→the terminal point T4→the terminal point T5→the terminal point T6→the terminal point T7→the terminal point T8”, and accordingly the cable overlap section is deleted. In this way, when all the overlap sections are deleted from the tentative cable run intra-route, the optimum cable route search means 15 determines the tentative cable run intra-route after deleting all the overlap sections as the formalized cable run intra-route.

That is, the optimum cable route search means 15 determines the tentative cable run intra-route obtained by deleting all the overlap sections from the tentative cable run intra-route shown in FIG. 6 “the terminal point T1→the terminal point T2→the terminal point T3→the terminal point T4→the terminal point T5→the terminal point T6→the terminal point T7→the terminal point T8” as the formalized cable run intra-route. When the formalized cable run intra-route is determined, the formalized cable run intra-route determination step is completed.

It should be noted that although it is not assumed for describing the tentative cable run intra-route search step that if a cable tray through which the cable passes with priority is previously set in the search condition (for example, identification number or the like of the cable tray), the optimum cable route search means 15 is adopted to search for a shortest cable route via the cable tray with the priority.

With reference again to FIG. 5, a description is given. When the formalized cable run intra-route determination step S15 is completed, subsequently, the flow proceeds to Step S16. In Step S16, the optimum cable route search means 15 performs the shortest cable route derivation step, and the cable route from the start point of the cable to the goal point of the cable, obtained by connecting the start point of the cable, the cable run intra-start point, the formalized cable run intra-route, the cable run intra-goal point and the goal point of the cable, is derived as the shortest cable route. The derived shortest cable route is recorded as the optimum cable route in the cable list 28.

It should be noted that the record to the cable list 28 is performed after the completion of the shortest cable route derivation step, but the record may be performed every time information is obtained. For example, in FIG. 9 to be described later, as the cable name and the start point and the goal point can be found from the cable specification information, at that stage, the record to the cable list 28 may be performed. Then, about the cable run intra-route too, as long as the formalized cable run intra-route determination step is performed, the record may be performed even before the completion of the shortest cable route derivation step.

Furthermore, the record of the cable specification information and the derived shortest cable route to the cable list 28 may be collectively performed along with the cable length record in a cable length calculation step to be described later.

A more specific description is given by using the tentative cable run intra-route shown in FIG. 6. The start point S and the goal point G outside the tray are respectively connected to the terminal point T1 and the terminal point T8, and further connected to the formalized cable run intra-route, thereby obtaining the shortest cable route from the start point of the cable to the goal point of the cable. That is, “the start point S→the terminal point T1→the terminal point T2→the terminal point T3→the terminal point T4→the terminal point T5→the terminal point T6→the terminal point T7→the terminal point T8→the goal point G” is derived as the shortest cable route. When the shortest cable route is derived, the shortest cable route derivation step is completed.

When the shortest cable route derivation step is completed, subsequently, in Step S17, the optimum cable route search means 15 performs the occupying rate update step for obtaining the sum of the cross sectional areas of the respective cables placed on each cable tray on the basis of the search result of the formalized cable run intra-route to update the occupying rate. The update of the occupying rate information on each cable tray is performed by updating the occupying rate information on each cable tray stored in the cable tray DB 24.

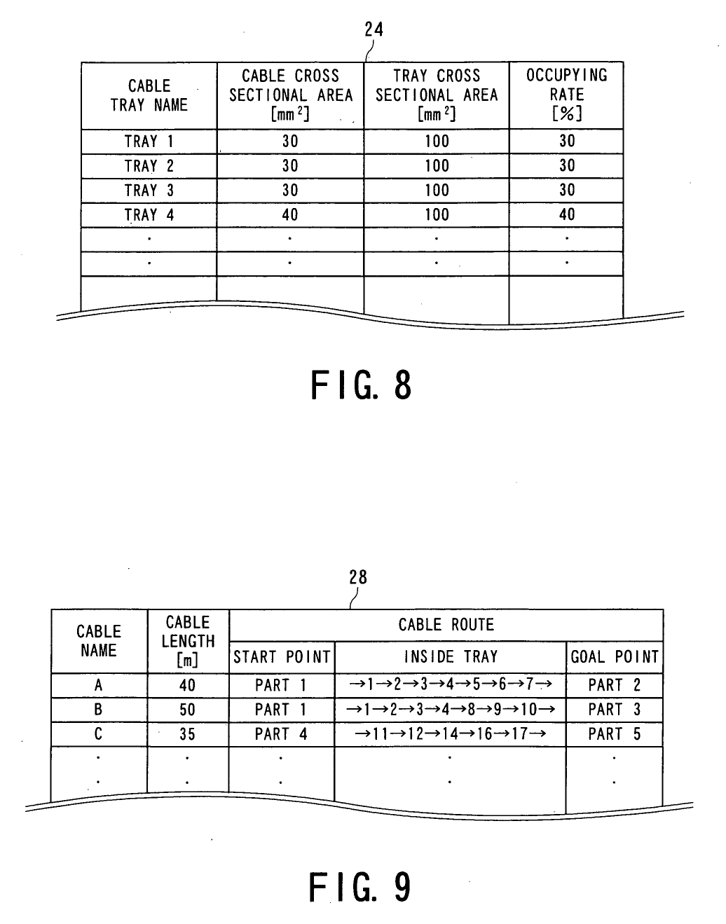

FIG. 8 is an explanatory diagram showing a data structure example of the cable tray DB 24 including the occupying rate information.

The data structure of the cable tray DB 24 has items of, for example, as shown in FIG. 8, the name of the cable tray for placing the cable (the cable tray part identification information), the cable cross sectional area indicating the total sum of the cross sectional areas of the cables placed on the cable tray, the cross sectional areas of the cable trays, and the occupying rate. In each cable tray, information on the cable cross sectional area total sum, the cable tray cross sectional area, and the occupying rate is recorded and saved.

In the occupying rate update step, the optimum cable route search means 15 updates, on the basis of the search result of the formalized cable run intra-route, the cable cross sectional area information by adding to the cross sectional area of the newly placing cable A to the cable cross sectional area before the search. Then, the new cable cross sectional area information is used to recalculate the occupying rate, and record and save a new calculation result.

When the optimum cable route search means 15 updates the occupying rate before the search into a latest (after the search) state, the occupying rate update step is completed. Then, with the completion of the occupying rate update step, all the processing steps in the shortest cable route search step (Step S3) are completed (“END” shown in FIG. 5).

Meanwhile, after the result of the tentative cable run intra-route search step, there may be no tentative cable run intra-route shown in FIG. 6. To be more specific, this case applies to an example where the optimum cable route search means 15 performs the same operation two times (for example, the case of T1→T2→T1→T2). In this way if the same operation is repeatedly performed two times, it is conceivable that the cable run itself such as the cable tray has no continuity, that is, two cable run parts at some positions are separated from each other.

As a result of the tentative cable run intra-route search step, when there is no tentative cable run intra-route shown in FIG. 6 (in the case of “NO” in Step S13), the tentative cable run intra-route search process is interrupted with respect to the cable A to generate the log file 29 having the search progress recorded (Step S18). By generating the log file 29, regarding the cable A, it is possible to support correction operation on the information to be stored in the contact point part arrangement information DB 21 and correction operation on the cable tray part arrangement information DB 22 and the contact part model 25 and the cable tray part model 26 to be performed later.

When the log file 29 is generated, the shortest cable route search step (Step S3) of FIG. 4 is completed, and the flow proceeds to “END”, where the cable quantity totalizing procedure is completed.

On the other hand, as a result of the tentative cable run intra-route search step, there is a case when the tentative cable run intra-route shown in FIG. 6 exists, but the tentative cable run intra-route shown in FIG. 6 has no cable overlap section. When the tentative cable run intra-route has no overlap section of the cable shown in FIG. 6 (in the case of “NO” in Step S14), the flow proceeds to Step S16, where the optimum cable route search means 15 performs the subsequent processing steps from Step S16.

It should be noted that the occupying rate update step in the shortest cable route search step is performed subsequently to the shortest cable route search step, but may be performed at any time after the formalized cable run intra-route determination step has been completed. That is, subsequently to the formalized cable run intra-route determination step, after the occupying rate update step is performed, the shortest cable route search step may be performed, or the occupying rate update step and the shortest cable route search step may be performed in parallel.

Subsequently, when the shortest cable route can be searched for (in the case of “YES” in Step S4), in Step S5, the cable length calculation step is performed. In the cable length calculation step, the cable route length calculation means 16 calculates a length L of the cable route searched for by the shortest cable route search step (hereinafter, abbreviated as the cable route length).

The cable route length L can be calculated by adding a length Ls from the start point of the cable to the cable run intra-start point, a route length Lt of the formalized cable run intra-route (hereinafter, simply referred to as the cable run intra-route length), and a length Lg from the cable run intra-goal point to the goal point of the cable. That is, the following expression is obtained.
L=Ls+Lt+Lg [Expression 1]

The length Ls from the start point of the cable to the cable run intra-start point and the length Lg from the cable run intra-goal point to the goal point of the cable can be found by using two point coordinate information and calculating the two point distance. Then, the cable run intra-route length Lt can be found by adding the respective lengths of the cable trays for placing the cables. Each length of the cable tray uses the length of the center line CL connecting the terminal points through which the cable passes.

A more specific example is given for describing the calculation method of the cable route length L. In the example shown in FIG. 2, the length Ls from the start point S of the cable (500, 100, 1000) to the cable run intra-start point T1 (500, 100, 3000) includes the two point distance 500−500=0 in the x-axis direction, the two point distance 100−100=0 in the y-axis direction, and the two point distance in the z-axis direction 3000−1000=2000, and is thus 2 m. Similarly, the length Lg from the cable run intra-goal point T8 (500, 4100, 3000) to the goal point G of the cable (500, 4100, 1000) also includes the two point distance of 2000, and is thus 2 m.

Moreover, in the cable run intra-route length Lt, as the formalized cable run intra-route is “the terminal point T1→the terminal point T2→the terminal point T3→the terminal point T4→the terminal point T5→the terminal point T6→the terminal point T7→the terminal point T8”, the cable tray passing through these terminal points T is the cable tray represented by the first straight type cable tray part model 26a₁, the first circular arc type cable tray part model 26b₁, the second straight type cable tray part model 26a₂, the T shape type cable tray part model 26c, the third straight type cable tray part model 26a₃, the second circular arc type cable tray part model 26b₂, and the fourth straight type cable tray part model 26a₄.

Herein, the length of the cable tray represented by the first straight type cable tray part model 26a₁ has a length corresponding to the distance of 3000 between the terminal point T1 and the terminal point T2, and thus is 3 m. Then, the length of the cable tray represented by the first circular arc type cable tray part model 26b₁ has a length corresponding to the distance (100 π) between the terminal point T2 and the terminal point T3, and thus is 0.1 π (=0.314) m.

Furthermore, the length of the cable tray represented by the second straight type cable tray part model 26a₂, the T shape type cable tray part model 26c, and the third straight type cable tray part model 26a₃ has a length corresponding to the distance of 3600 between the terminal point T3 and the terminal point T6, and thus is 3.6 m.

In addition, the length of the cable tray represented by the second circular arc type cable tray part model 26b₂ has a length corresponding to the distance (100 π) between the terminal point T6 and the terminal point T7, and thus is 0.1 π (=0.314) m. The length of the cable tray represented by the fourth straight type cable tray part model 26a₄ has a length corresponding to the distance of 3000 between the terminal point T7 and the terminal point T8, and thus is 3 m. Therefore, the cable run intra-route length Lt can be found by calculating 3 m+0.314 m+3.6 m+0.314 m+3 m, and thus the cable run intra-route length Lt=10.228 m is found.

If the respective terms of Expression 1, that is, the values of the length Ls from the start point of the cable to the cable run intra-start point, the cable run intra-route length Lt, and the length Lg from the cable run intra-goal point to the goal point of the cable are assigned, the cable route length L=2+10.228+2=14.228, and thus the cable route length L can be calculated as 14.228 m. The calculated result is recorded and saved in the cable list 28.

FIG. 9 is an explanatory diagram showing a data structure of the cable list 28 recorded and saved in the memory means 13 of the cable quantity totalizing device 10.

For example, as shown in FIG. 9, the data structure of the cable list 28 has information, for each cable unit, on a cable name (cable identification information), a necessary cable length, and a route for placing the cable as described items. It should be noted that a numeral indicated in an item “intra-tray” denotes identification information (the part identification information on the cable tray part model) representing the cable tray.

When the cable route length calculation means 16 calculates the cable route length searched for in the shortest cable route search step, that is, the cable route length L, the cable length calculation step is completed. Next, in Step S6, the all search target search completion confirmation step is performed.

In the search target search completion confirmation step, the optimum cable route search means 15 confirms whether or not the shortest cable route search has been completed for all the cables as the cable route search targets, and the cable route length calculation means 16 confirms whether or not the calculation of the cable route length L searched for in the shortest cable route search step has been completed. When the shortest cable route search has been completed for all the cables as the cable route search targets and the calculation of the cable route length L has been completed (in the case of “YES” in Step S6), next, the flow proceeds to Step S7. In Step S7, the search result display step is performed.

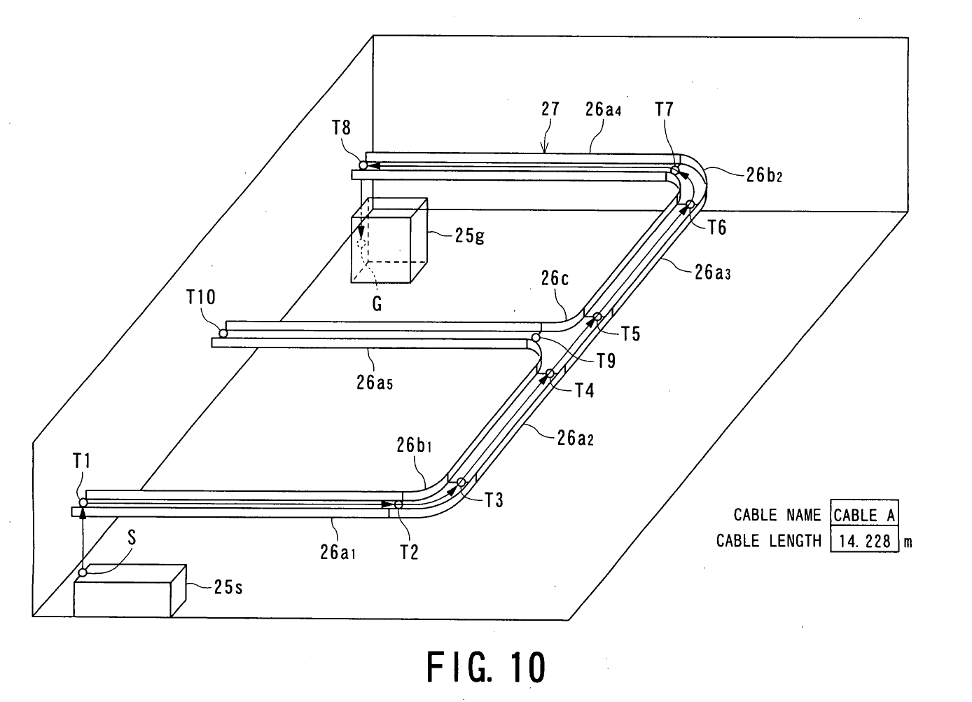

FIG. 10 is an explanatory diagram showing examples of the shortest cable route search result and the cable length calculation result displayed on the display means 12 in the search result display step.

In the search result display step, the shortest cable route search result (the optimum cable route search result) in the shortest cable route search step and the cable length calculation result in the cable length calculation step are displayed on the display means 12, for example, in a format shown in FIG. 10.

That is, regarding the optimum cable route search result, on the basis of image information showing arrangement states of the contact part model 25 and the cable tray part model 26 received from the three dimensional model arrangement adjusting means 14 and image information showing the cable route search result (the route connecting the start point, the passing terminal points T, and the goal point) received from the optimum cable route search means 15, the optimum cable route search result is three dimensionally displayed on the display means 12.

Furthermore, on the basis of image information showing the cable route length received from the cable route length calculation means 16, the cable length calculation result is displayed on the display means 12.

It should be noted that regarding the optimum cable route search result and the cable length calculation result, the data is read from the memory means such as the cable list 28 where the data is recorded and saved as the cable search result, and the thus obtained image information is sent to the display means 12, and the cable list 28 shown in FIG. 9 may be displayed on the display means 12.

When the shortest cable route search result in the shortest cable route search step and the cable length calculation result in the cable length calculation step are displayed on the display means 12, the search result display step is completed. Upon the completion of the search result display step, all the processing steps in the cable quantity totalizing procedure have been completed (“END”).

Meanwhile, if the shortest cable route cannot be searched for in the shortest cable route search step S4 (in the case of “NO”), that is, as a result of the tentative cable run intra-route search step in the shortest cable route search step in Step S3, if there is no tentative cable run intra-route (in the case of “NO” in Step S13), the flow proceeds to Step S8, where the optimum cable route search means 15 refers to the generated log file 29 to display a message that there is no tentative cable run intra-route and the search progress on the screen as the search result (search result display step). It should be noted that the search result displayed on the screen in Step S8 may include at least one of the message that the tentative cable run intra-route and the search progress.

In addition, if the shortest cable route search and the calculation of the cable route length L have not been completed for all the cable as the cable route search targets (in the case of “NO” in Step S6), the flow returns to Step S3, where the subsequent processes from Step S3 are repeatedly performed.

It should be noted that in the cable quantity totalizing procedure shown in FIG. 4, first of all, in Step S1, the part information obtaining step is performed, and subsequently, in Step S2, the search condition obtaining step is performed. However, the search condition obtaining step may be firstly performed, and thereafter, the part information obtaining step may be performed, or both the steps may be performed in parallel.

In addition, when a building has a plurality of storeys, it is necessary to select the cable tray on the same storey. In this case, it is possible to cope with the situation if another setting file is used to read in the upper and lower range in the storey.

Subsequently, the cable quantity totalizing PG according to the present invention will be described.

As described above, the cable quantity totalizing PG according to the present invention is a PG for causing a computer to serve or function as the cable quantity totalizing device 10, and in other words, a PG for causing the computer to execute the cable quantity totalizing procedure.

The cable quantity totalizing device 10 realized at a time when the computer executes the cable quantity totalizing PG 18 and the cable quantity totalizing procedure realized at a time when the computer executes the cable quantity totalizing PG 18 are the same as those described above.

As described above, according to the cable quantity totalizing device, the cable quantity totalizing method, and the cable quantity totalizing program according to the present invention, since the cable run part model 27, such as cable the cable tray whose number of parts is smaller than that of the cable and which significantly affects the cable route, is used, the search of the optimum cable route and the route length (quantity totalizing) can be conducted without degrading the calculation accuracy as compared with the prior art.

Moreover, it suffices if the three dimensional CAD data necessary for the search has one for the parts functioning as the start point and the goal point and one for the cable tray part. Therefore, when the necessary contact part, the cable tray part, the position of each part, and the cable to be used are determined, the search for the optimum cable route using the three dimensional model already generated by the three dimensional arrangement adjusting CAD device can be performed. Thus, the load on the three dimensional CAD data generation is only necessary minimum, thus being efficient.

Furthermore, the use of the three dimensional data makes it possible to display the search result (the optimum cable route) three dimensionally, and enables the user to recognize the optimum cable route in a three dimensionally manner, so that the optimum cable route can be presented to the user in a more comprehensive way as compared with the prior art. Moreover, even a person who is not the cable designer (for example, an administrator) can easily understand the states including the optimum cable route and the occupying rate of each cable tray in the cable planning stage.

The cable list 28 generated as the cable quantity result can be output as a cable arrangement ledger sheet, and used as the cable design down stream development. Then, the terminal points through which the cable passes are described in sequence in the cable list 28. In a plant site, the cable list can also be used as the installation instruction material for placing the cable and the instruction ledger sheet. Therefore, the burden on the operator in the site can be suppressed.

On the other hand, as the search condition, if the occupying rate, the placing priority, the tray priority, and the like are set, the cable route search in consideration of these search conditions can be conducted. That is, the optimum cable route can be searched for under various conditions. For example, in an example in which the occupying rate is set, when exceeding a setting value of the occupying rate, another cable root is searched.

In addition, upon the optimum cable route search, if the cable tray through which the cable must pass is provided with the tray priority, the cable route via the cable tray provided with the tray priority can be searched for with certainty, which is convenient for the cable route design.

It should be noted that the cable quantity totalizing device 10 shown in FIG. 1 may be an optimum cable route search device. In the case of the optimum cable route search device, the cable quantity totalizing device 10 show in the drawing may omit the cable route calculation means 16.

Then, in the cable quantity totalizing device 10, the cable use information stored in the cable specification DB 23 may have information defining priority in the route search, and the optimum cable route search means 15 may conduct the cable route search in consideration with the priority.

Furthermore, in the cable quantity totalizing device 10, the three dimensional model arrangement adjusting means 14 is independent as another device. The three dimensional model arrangement adjusting means may be connected to the cable quantity totalizing device via interface means, not shown in the drawing).

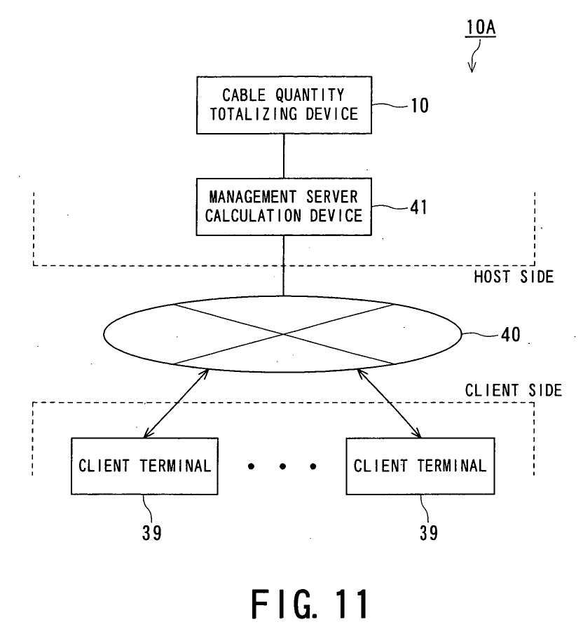

Meanwhile, as another embodiment, as shown in FIG. 11, the cable quantity totalizing device 10A may further include a management server calculation device 41 capable of performing data exchange with a client side (at least one client terminal 39) via a communication network 40. It should be noted that in a cable quantity totalizing device 10A shown in FIG. 11, the client side (at least one client terminal 39) and the management server calculation device 41 do not necessarily need the intermediation of the communication network 40.

What is claimed is:

1. A cable quantity totalizing device comprising;
an input unit configured to perform an inputting operation of information;
a memory unit as a database configured to store arrangement information and part identification information related to a three dimensional model of a contact point part having a contact point with a cable, arrangement information, part identification information and attribute information related to a three dimensional model of a cable container part for containing a cable when placed, cable specification information on the cable, and occupying rate information on the respective cable container parts;
a three dimensional model arrangement adjusting unit configured to arrange a three dimensional model in a three dimensional coordinate system obtained by simulating a space where a cable is actually placed;
a cable route search unit configured to read out the information on the cable container part stored in the database to search for a cable route with a shortest cable length;
a cable route calculation unit configured to calculate the cable length in the cable route searched for by the optimum cable route search unit; and
a display unit configured to display the cable route search result and the cable length calculation result.

2. The cable quantity totalizing device according to claim 1, wherein the three dimensional model arrangement adjusting unit is configured to edit the three dimensional model data stored in the database, the three dimensional model arrangement information and the part identification information of the contact point, and the arrangement information, the part identification information and the attribute information related to the three dimensional model of the cable container part.

3. The cable quantity totalizing device according to claim 1, wherein the optimum cable route search unit is configured to perform a search for a cable route which meets a previously obtained search condition and has the shortest cable length, and the search condition is at least one of a proportion of a total cable area to a sectional area of the cable container part, a priority of the placing cable, and a priority of the cable container part used for cable placement.

4. The cable quantity totalizing device according to claim 1, wherein the cable specification information includes at least identification of the cable, sectional area information, and part identification information on three dimensional models of contact point parts functioning as a start point and a goal point.

5. The cable quantity totalizing device according to claim 1, wherein the optimum cable route search unit is configured to set as an optimum route a cable route obtained by connecting a cable run intra-route obtained by sequentially searching for a start point of a cable, a terminal point of a cable container part closest to the terminal point of the cable container part closest to the goal point of the cable the start point of this cable, and terminal points of a cable container part closest to a goal point of the cable among terminal points adjacent to the terminal point of the cable container part closest to the start point of the cable, with terminal points of the cable container part closest to the goal point of the cable.

6. The cable quantity totalizing device according to claim 5, wherein in a case that there exists an overlap section in the cable run intra-route obtained by sequentially searching for terminal points of the container part closest to the goal point of the cable among terminal points adjacent to the terminal point of the cable container part closest to the start point of the cable and searching for the route to the terminal point of the cable container part closest to the goal point of the cable, the optimum cable route search unit is configured to delete the overlap section from the cable run intra-route.

7. The cable quantity totalizing device according to claim 1, wherein the optimum cable route search unit includes a cable list editing element having a function of editing a cable list and a log file which are output as a result of the cable quantity totalizing.

8. The cable quantity totalizing device according to claim 1, wherein the display unit is configured to receive image information indicating an arrangement state of the three dimensional model, image information indicating the search result, and image information indicating the calculation result so as to three dimensionally display the search result and the calculation result.

9. A cable quantity totalizing method comprising:
a part information obtaining step of obtaining arrangement information and part identification information related to a three dimensional model of a contact point part having a contact point with a cable, arrangement information, part identification information and attribute information related to a three dimensional model of a cable container part for containing a cable when placed, and cable specification information on the cable;
a search condition obtaining step of obtaining a search condition in a shortest cable route search;
a shortest cable route search step of searching for a shortest cable route under a condition obtained in the search condition obtaining step;
a cable length calculation step of calculating, when the shortest cable route is searched for in the shortest cable route search step, a length of the cable route searched for in the shortest cable route search step; and
a search result display step of displaying and outputting, when the shortest cable route is searched for in the shortest cable route search step, the shortest cable route and the cable length, and outputting, when the shortest cable route is not searched for in the shortest cable route search step, a message that the shortest cable route is not searched for.

10. A cable quantity totalizing program for causing a computer to execute a cable quantity totalizing procedure which comprises:
a part information obtaining step of obtaining arrangement information and part identification information related to a three dimensional model of a contact point part having a contact point with a cable, arrangement information, part identification information and attribute information related to a three dimensional model of a cable container part for containing a cable when placed, and cable specification information on the cable;
a search condition obtaining step of obtaining a search condition in a shortest cable route search;
a shortest cable route search step of searching for a shortest cable route under a condition obtained in the search condition obtaining step;
a cable length calculation step of calculating, when the shortest cable route can be searched for in the shortest cable route search step, a length of the cable route searched for in the shortest cable route search step; and
a search result display step of displaying and outputting, when the shortest cable route can be searched for in the shortest cable route search step, the shortest cable route and the cable length, and outputting, when the shortest cable route cannot be searched for in the shortest cable route search step, a message that the shortest cable route cannot be searched for.
